(19) United States
(12) Patent Application Publication
(10) Pub. No.: US 2021/0351849 A1
(43) Pub. Date: Nov. 11, 2021

(54) COMMUNICATION SYSTEM

(71) Applicant: WFS Technologies Limited, Livingston (GB)

(72) Inventor: Brendan Peter Hyland, Livingston (GB)

(73) Assignee: WFS Technologies Limited, Livingston (GB)

(21) Appl. No.: 17/268,425

(22) PCT Filed: Aug. 13, 2019
(86) PCT No.: PCT/EP2019/071724

§ 371 Date: Feb. 12, 2021

(30) Foreign Application Priority Data
Aug. 13, 2018 (GB) 1813181.3
Sep. 21, 2018 (GB) 1815440.1

(51) Int. Cl. H04B 13/02; H04W 4/38; H04B 5/00; H02J 50/10

(52) U.S. Cl. CPC H04B 13/02; H04W 4/38; H02J 50/10; H04B 5/0037; H04B 5/0031

(57) ABSTRACT

A communication system comprising a communication unit having a local wireless communication mechanism, a remote wireless communication mechanism, a processor, and a power supply; and, at least one of a sensor unit having a sensor mechanism, a local wireless communication mechanism and a power supply. Each of the communication unit and at least one sensor unit is provided in a discreet housing and can be arranged proximal to each other unit to form a cluster. Each local wireless communication mechanism can communicate data to each other local wireless communication mechanism within the cluster. The communication unit remote wireless communication mechanism is operable to communicate outwith the cluster.

The present invention relates to a communication system and, in particular, an underwater communication system formed of a cluster of communications units.

As communication of data becomes an increasingly important part of the modern world so too do effective ways of implementing useful data communication in all environments.

Over the past decade, communication of data underwater or through water has increased in capability due to the development of through fluid data transmission techniques using electromagnetic data carrying signals. In addition, data communication techniques including hybrid systems which use one or more of electromagnetic, acoustic or optical data signal transmission have also become more commonplace. Integration of communication systems with existing infrastructure to provide data, and control and command capabilities, either as ongoing real-time communication or for data collection and retrieval, has extended the utility of underwater communication systems. However, implementation of underwater systems can still be limited by the environment in which the system is deployed. The damaging effect of water on electronic and mechanical components can reduce system lifespan.

The difficulty of achieving watertight connectors creates an inherent weakness in the design of multi-component systems which are to be deployed underwater. Furthermore, long term power provision in an underwater environment is an issue. Cable connections are costly to install and create and additional weak point in the system as they are relatively fragile and vulnerable to damage. Battery lifespans are limited and the cost of swapping out battery system in an underwater environment, or retrieving the whole system to topside to replace the battery is a costly and complex undertaking.

It is an object of the current invention to obviate or mitigate at least one of the aforementioned problems.

According to a first aspect of the present invention there is provided a communication system comprising a communication unit having a local wireless communication mechanism, a remote wireless communication mechanism, a processor, and a power supply; and, at least one of a sensor unit having a sensor mechanism, a local wireless communication mechanism and a power supply, wherein each of the communication unit and at least one sensor unit is provided in a discreet housing and is arranged proximal to each other unit to form a cluster such that each local wireless communication mechanism can communicate data to each other local wireless communication mechanism within the cluster and the communication unit remote wireless communication mechanism is operable to communicate outwith the cluster.

By arranging the sensor units and communication unit in a cluster such that their local wireless communication mechanisms can transmit data to each other within the cluster the system. In addition, the remote wireless communication mechanism means the communication unit is operable to communicate on behalf of the cluster with the outside world. The communication functionality allows for the operation of transmitting data within the cluster can operate at a lower power level preserving battery life within the individual units of the cluster for longer whilst power can, when needed, be expended for long range remote transmission of the data.

Each discreet housing may be a waterproof housing. By having waterproof unit housings, the system can be deployed in hard to reach locations which can be subject to extreme conditions and yet the cluster and thus system will still operate.

The communication system may be an underwater communication system. Waterproof discreet housings mean that the units forming the cluster can operate underwater and thus the system may be deployed in an underwater environment.

The communication system may include at least two sensor units. Each sensor unit may include the functionality of one or more of a temperature sensor, accelerometer, pressure sensor, flow meter, vibration monitor, acoustic sensor, optical sensor, corrosion monitoring sensor, strain sensor, integrity sensors, oxygen level sensor and the like. By incorporating more than one sensor type, within a sensor unit or within a cluster, more data relating to the environment being monitored may be gathered.

The communication system may include more than one sensor unit having a given type of functionality. By duplicating sensor functionality, the system is able to provide redundancy, thus compensate for potential failure of any given sensor unit. The provision of multiple duplicate functionality units, thus providing a RAID architecture, the array or redundant sensors can enhance processing and analytics capability.

The communication system may comprise more than one communication unit. By providing more than one communication unit, the communication system is provided with redundancy thus ensuring that failure of a communication unit does not result in complete loss of data from and communication with the communication system.

Each communication unit and/or each sensor unit may include a power transfer system to transfer power inductively between units. By providing a power transfer system, equalisation of power supply across the units can be managed within the system to prolong system lifespan.

Each sensor unit may comprise a local processor mechanism. By providing a local processing mechanism within each sensor, the sensor units may act upon sensed data to minimised the data required to be transmitted thus potentially further reducing the power required for data transmission locally.

The communication system may further comprise a frame operable to receive each of the communication units and sensor units. The frame enables the individual units of the cluster to be retained in a formation relative to one another and held securely as part of the cluster.

The frame may comprise a material operable to allow electromagnetic data carrying signals to propagate between local communication mechanisms. By constructing the frame of a material operable to propagate electromagnetic data carrying signals between the local communication mechanisms, the power requirement for data transmission between the local communication mechanisms is further reduced thus further reducing the operational power requirements of the individual units and the communication system as a whole.

Alternatively, each communication unit and sensor unit housing may be provided with a plurality of securing mechanisms with each securing mechanism operable to co-operate with a securing mechanism on another unit such that the units can be secured together to form a cluster. By having securing mechanisms provided on the housing, each unit can be clipped together to another unit such that they can be held in a cluster without need for an external frame.

According to another aspect of the invention there is provided a frame for a communication system, the frame comprising a plurality of recesses, each recess operable to receive one of a communication unit or a sensor unit, wherein the plurality of recesses are arranged to hold a plurality of units proximal to one another.

The frame for a communication system enables individual communication system units to be arranged as a cluster and retained in a formation relative to one another and held securely as part of the cluster.

The frame may comprise a material operable to allow electromagnetic data carrying signals to propagate wirelessly between units. By constructing the frame of a material operable to propagate electromagnetic data carrying signals between communication units, the power requirement for data transmission between units is reduced thus reducing the operational power requirements of the individual units and the communication system as a whole.

According to a third aspect of the invention there is provided a communication network comprising a communication system of the first aspect of the invention, and a mobile communication unit, the mobile communication unit operable to communicate with the communication system and identify the status of each communication unit and sensor unit within the communication system.

The mobile communication may be provided with at least one sensor unit wherein the mobile communication unit is operable to remove a sensor unit from the communication system and replace it with the at least one sensor unit with which the mobile communication unit is provided. By providing the mobile communication unit with at least one spare sensor unit, the mobile communication unit can identify the status of the units within the communication system and swap any defective sensor unit with the sensor unit which it is carrying.

The mobile communication unit may be provided with at least one communication unit wherein the mobile communication unit is operable to remove a communication unit from the communication system and replace it with the at least one communication unit with which the mobile communication unit is provided. By providing the mobile communication unit with another one or more communication units, the mobile communication unit can identify the status of the units within the communication system and swap any defective communication unit with the communication unit which it is carrying.

The communication network may further comprise a command and control centre. The command and control centre is able to direct the communication system and mobile communication unit to operate as a network, manage power supply and component operation and ensure required data is recorded, processed and provided to the command centre for further use.

The communication network may further comprise a user interface which enables a user to review communication system status and input control data in response to specific status outputs.

Embodiments of the present invention will now be described, by way of example only, with reference to the accompanying drawings in which:

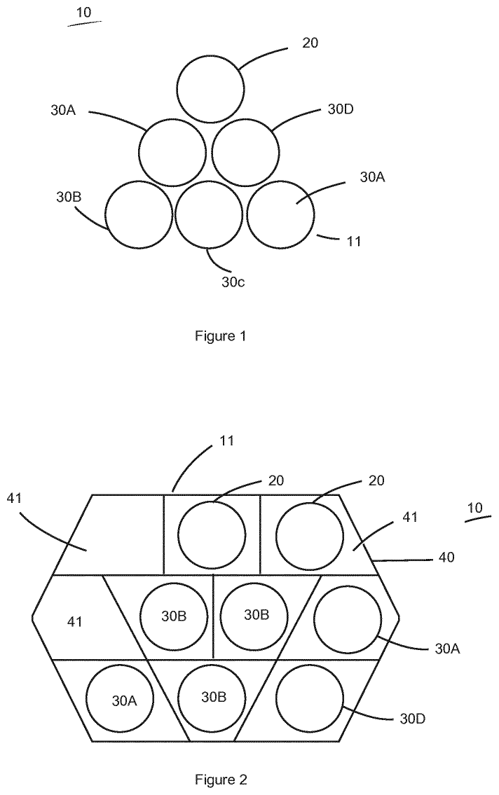

FIG. 1 is a schematic illustration of a communication system according to an embodiment of the present invention;

FIG. 2 is a schematic illustration of a communication system according to another embodiment of the present invention;

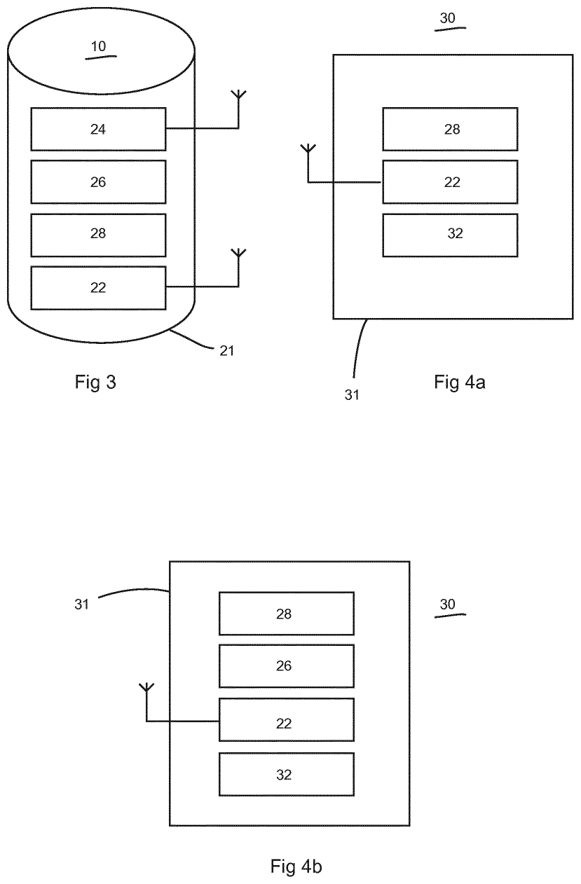

FIG. 3 is a schematic illustration of a communication unit for use in an embodiment of a communication system of the present invention;

FIG. 4a is a schematic illustration of a sensor unit for use in an embodiment of a communication system of the present invention;

FIG. 4b is a schematic illustration of an alternative sensor unit for use in an embodiment of a communication system of the present invention;

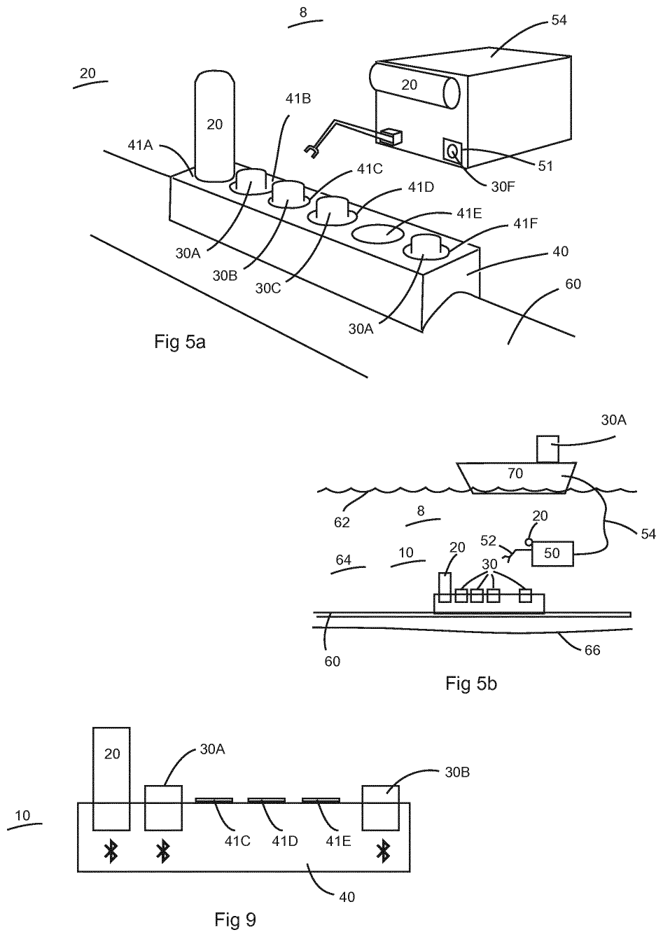

FIG. 5a is a perspective illustration of an embodiment of a communication network according to the present invention;

FIG. 5b is a schematic diagram of an embodiment of a communication network of the present invention;

FIG. 6 is a cross section diagram of a communication system according an embodiment of the present invention;

FIG. 7 is a schematic representation of a user interface for use in a communication network of an embodiment of the invention;

FIG. 8 is another representation of a user interface for use in a communication network of an embodiment of the invention;

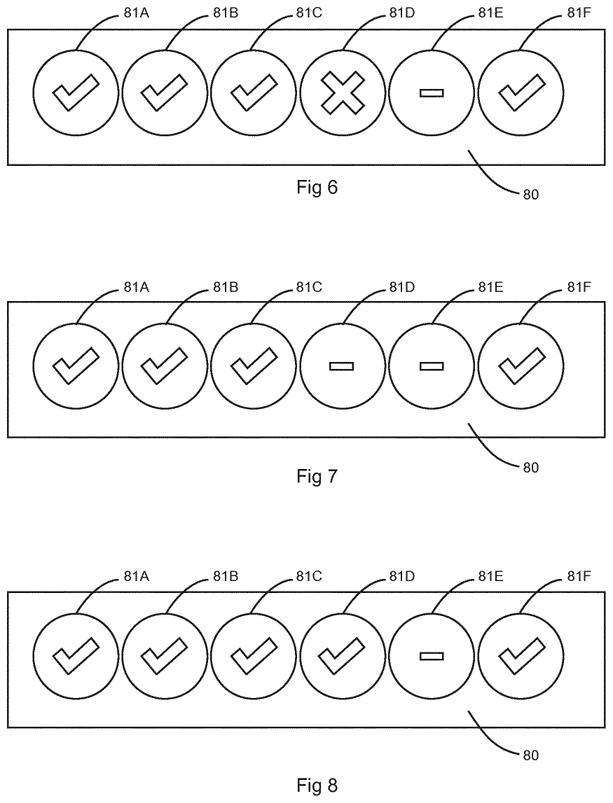

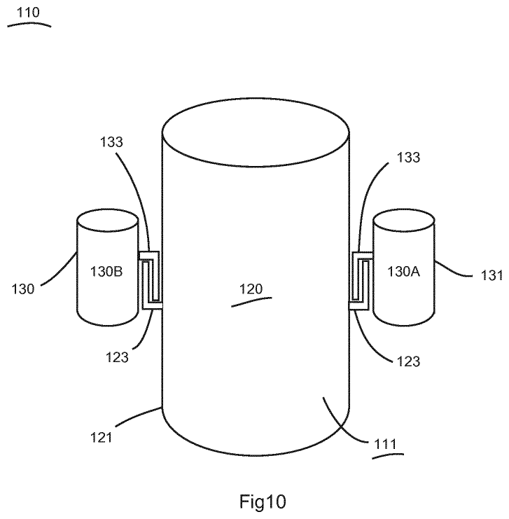

FIG. 9 is another representation of a user interface for use in a communication network of an embodiment of the invention;

FIG. 10 is another embodiment of a communication system according to the present invention;

FIG. 11 is another embodiment of a communication system according to the present invention;

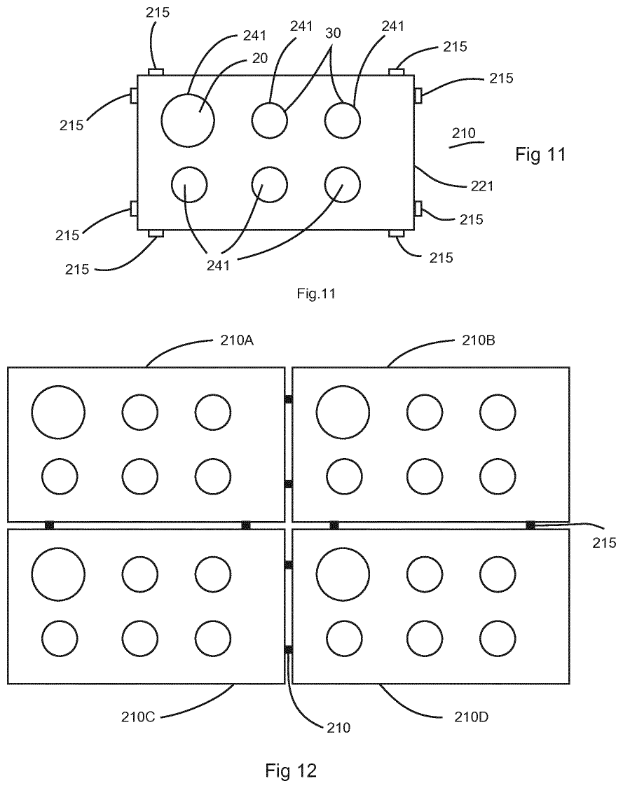

FIG. 12 is an embodiment of a communication system array according to the present invention;

FIG. 13 is another embodiment of a communication system according to the present invention;

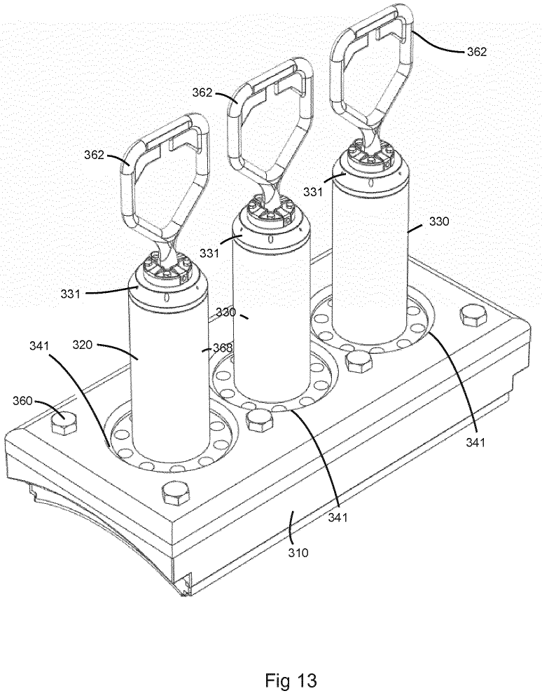

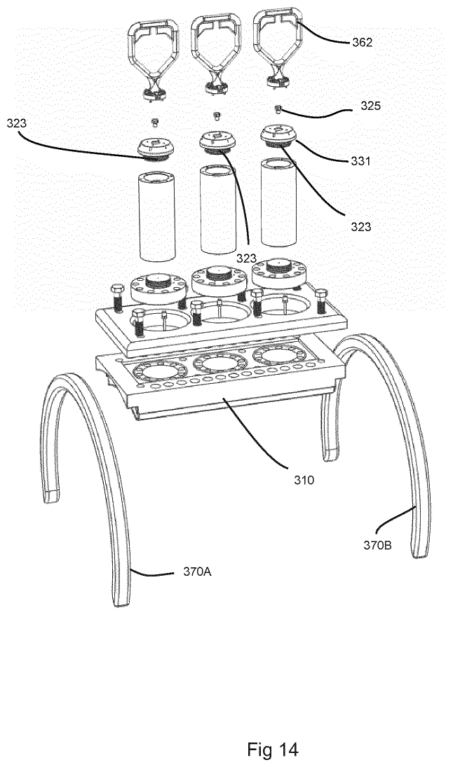

FIG. 14 is an explode view of another embodiment of a communication system according to the present invention, and

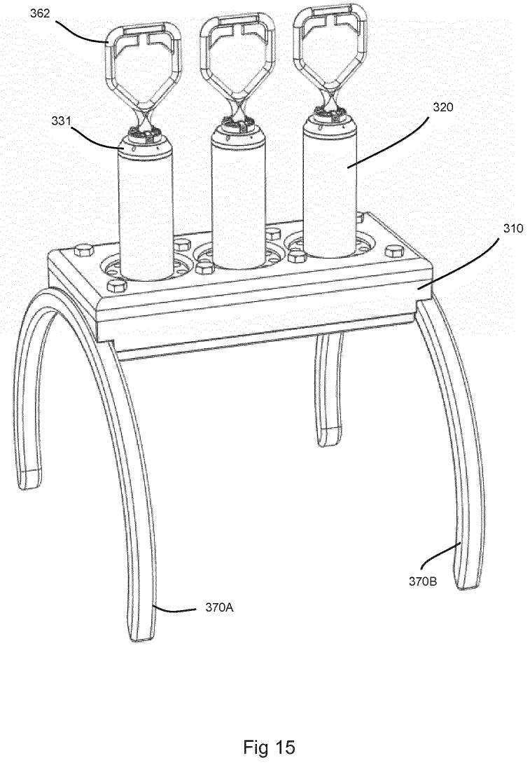

FIG. 15 is an assembled view of the communication system of FIG. 14.

As is shown in FIG. 1, there is provided a communication system 10 comprising a communication unit 20 and multiple sensor units 30.

The underwater communication unit 20 is shown in more detail with reference to FIG. 3 and comprises a housing 21 within which is provided a local communication mechanism, in this case a high frequency electromagnetic transceiver 22, a remote communication mechanism, in this case an electromagnetic transceiver 24 having a signal frequency lower than the local transceiver 22, a processor 26 and an internal power supply, in this case a battery 28. The processor 26 has processing capability to generate command and control signals as well as processing and analyzing data received from sensor units 30 and functioning as an artificial intelligence engine.

An embodiment of a sensor unit 30 is shown in FIG. 4A in which the sensor unit 30 comprises a housing 31, a sensor 32, and internal power supply, in this case battery 28, and a local communication mechanism, in this case a high frequency electromagnetic transceiver 22.

In FIG. 1, the communication system 10 is provided with a communication unit 20 and five sensor units, in this case units 30A—D, with two sensor units 30A. In this embodiment, the sensor 32 of sensor unit 30A is a temperature sensor. In sensor unit 30B, the sensor 32 is an accelerometer. The sensor 32 of sensor unit 30C is a vibration monitor. The sensor 32 of sensor unit 30D is an oxygen levels sensor.

The communication unit 20 and each sensor unit 30A, A, B, C and D is provided in a discreet housing 21, 31 respectively which is watertight. Units 20, 30A, A, B, C and D are arranged proximal to each other to form a unit cluster 11 such that each local transceiver 22 can wirelessly communicate data to other unit local transceivers 22 within the unit cluster 11 using high frequency electromagnetic signal transmission. The communication unit remote transceiver 24 is operable to wirelessly communicate with a remote system (not shown) using electromagnetic signal transmission of a lower frequency than the local transceivers.

It will be appreciated that the communication system 10 can be an underwater communication system. The communication system 10 can, as is shown in FIG. 1, include at least two of each type of unit 30A, B, C for increased operational resilience as data sets can be duplicated and processing mechanisms can run in parallel to allow for verification of performance and data rigour as well as providing back up on the occurrence of any single unit failure. Such integral redundancy is particularly use during use in an underwater environment as it provides for a more robust communication system and more robust data acquisition particularly in extreme or hard to access environments.

Each local transceiver 22 is operable to communicate wirelessly with each other local transceiver 22 using a wireless a high frequency electromagnetic communication technique and it will be appreciated that a frequency range such as Bluetooth frequency ranges would be useful. Use of Bluetooth transmission allows for low power, high data rate communication which is useful in ensuring battery power usage is optimized which is a considerable advantage for units 20, 30 operating in waterproof, sealed for life enclosures 21, 31. It will also be appreciated that use of wi-fi transmission range may be used to optimize a high data transmission rate but this will see more consumption of battery power.

It will be appreciated that each sensor unit 30 may include one or more of, for example, but not limited to, a temperature sensor, accelerometer, pressure sensor, flow meter, vibration monitor, acoustic sensor, optical sensor, corrosion monitoring sensor, strain sensor, integrity sensors and the like.

In FIG. 4B, another embodiment of a sensor unit 30 is shown in which the sensor unit 3 comprises a housing 31, a sensor 32, and internal power supply, in this case battery 28, and a local communication mechanism, in this case a high frequency electromagnetic transceiver 22 as well as a processor 26. The provision of a processor 26 within each sensor unit 30 enables data processing to occur on the data harvested by sensor 32 thus enabling only relevant or predetermined data to be transmitted to other units within the system 10 by local communication mechanism 22 thus reducing the battery power consumption associated with excessive data transmission.

As is shown in FIG. 2, the communication system 10 can be provided with frame 40. The frame 40 is provided with a plurality of recesses 41, each recess 41 operable to receive a communication unit 20 or sensor unit 30. The recesses are arranged to hold a plurality of units proximal to one another in a cluster formation 11. In this embodiment, there is provided two communications units 20, 20, with a duplication provided for the purposes of redundancy and thus provide duplicate or complimentary, or both duplicate and complementary functionality, and six sensor units 30A, A, B, B, C and D, with duplication of 30A and 30B for the purposes of redundancy to ensure data isn't lost with failure of one of these components 20, 30A, 30B. Two recesses 41 are unfilled but it will be appreciated that further sensor units could be introduced into the system 10 as desired using the void recesses 41 to house them. The frame 40 is formed of any material suitable for enabling propagation of electromagnetic waves between the local transmission mechanisms including but not limited to plastic, polythene and, in this embodiment, acetal.

In a further embodiment, the frame 40 can be an active device which interacts with the units mounted therewithin. For example, the frame can be provided with solenoids which identify when a sensor unit is mounted within a recess 41. Alternatively, solenoids can be wirelessly actuated by, for example, the AUV during the assembly and/or swapping out process. The frame can be provided with an integral communication unit or sensor unit construction so that it is operable to communicate with the units 20, 30 housed there within or alternatively, it can interrogate the units housed there within to establish their status and performance levels. The frame 40 can then, as is the case with the communication unit 20, perform a diagnostic function within the system. It can be further operable to communicate with a remote communication system. It will be appreciated that the communication unit housing 21 may form the frame with the sensor units 30 being inserted into recesses as required thus further reducing the workload on individual sensor units 30 in transmitting data thus lowering their power consumption further. The communication unit, or communication unit enabled frame can be provided with an external antenna deployed, for example, on the seabed and this would enable the system 10 to communicate directly with other communication system or transceiver located a considerable distance away.

With reference to FIGS. 5A and 5B, there is shown a communications network 8 which includes communication system 10 mounted on a subsea pipeline 60 which is arranged close to seabed 66. The system 10 is secured to pipeline 60, in this embodiment by magnets disposed in frame 40. However, it will be appreciated that any suitable securing mechanism may be used including, but not limited to, straps of a resilient clip mechanism. The network further comprises remotely operated vehicle (ROV) 50 which is provided with communication unit 20, mechanical arm 52 and recess 51 in which can be held at least one sensor unit 30 or communication unit 20 for swapping out with a sensor unit 30 or communication unit 20 of system 10. In this case, the recess 51 houses a sensor unit 30F which is provided with a sensor 32 which has multiple functionality including temperature sensing, vibration sensing and pressure sensing however it will be appreciated it may be a single criteria sensor or a different set of multi-parameter sensor functionality. ROV 50 is connected to vessel 70 on the surface 62 of the sea 64 by umbilical 54. The vessel 70 is provided with a command and control centre 72 from which users can monitor the status and performance of ROV 50, as well as provide command and control data to it, and review data received by the ROV 54 from communication system 10 via data transmission between communication units 20 using their remote communication mechanism 24.

In this embodiment, the communication system 10 has a frame 40 provided with six recesses 41A—F, which a communication unit 20 arranged in recess 41A and sensor nodes 30A, B, C, A housed in recesses 41B, C, D and F respectively. Recess E is empty.

The communication unit 20 of the ROV 50 can interrogate communication unit 20 of system 10 and establish the status of each of the units 20, 30 including criteria such as battery level, stored data, performance efficiency or any other issues relating to structural or performance of the units. This data can be processed locally in communication unit 20 of the ROV 50, and thus an adjustment can be actioned locally, or the data can be provided, either in a processed or unprocessed state, to command centre 72.

With reference to FIGS. 6 to 8, when the ROV 50 in FIGS. 5a,b interrogates communication system 10, it is established that sensor unit 30C in recess 41D is faulty. The output display which will be seen on a user interface 80 within the command and control centre 72 is shown in FIG. 6. As can be seen, identifier 81D which corresponds to recess 41D shows a cross indicating unit failure. By contrast, identifies 81A, B, C and F, which correspond to communication unit 20 and sensor units 30A, 30B and 30A are showing a tick, which indicates the unit is performing at a required level. The recess 41E is empty and as a result, indicator 81E shows a dash indicating no units are present.

As ROV 50 is able to interrogate system 10 and establish this status either the ROV 50, or a user in command and control centre 72 can determine that the ROV 50 should remove the faulty unit 30C using mechanical arm 52 and replace it with sensor unit 30F.

During this process, ROV 50 continues to communicate with the system 10 and the output at the user interface 80 when the faulty unit 30C is removed from recess 41D is shown in FIG. 7 with indicators 80A, B, C and F all showing a tick and indicators 81D and 81E showing a dash which indicates no units are housed in these recesses.

The ROV 50 can then place sensor unit 30F into recess 41D and, when it is fully inserted, the communication unit 20 of system 10 can interrogate the sensor unit 30F and confirm it is operational, this confirmation is feedback to ROV 50 and the user interface 80 will subsequently show the output illustrated in FIG. 8 with a tick now in indicator 81D.

As is shown in FIG. 9, even if recesses 41C, D and E are all empty, the remaining units 20, 30A and 30B can continue to communicate locally using Bluetooth communication techniques and when frame 40 is formed of a material such as acetal, this enhances the communication between the units 20, 30A, 30B.

In FIG. 10, another embodiment of communications system 110 is shown in which like components with the embodiments referred to in system 10 are referred to using the same reference numerals. In this embodiment, communication unit 120 has housing 120 which is provided with clip protrusions 123. Communications system 110 further comprises sensor units 130A, 130B each having discreet housing 131 which is provided with clip projection 133. Clip projection 133 co-operates with clip protrusion 123 to releasably secure sensor units 130A, 130B to communications unit 110 to create a cluster 111. When any units of 120, 130A, 130B are defunct, it is possible to unclip and replace the non-operational unit in situ and reattach the new unit to the remaining units using clips 123, 133.

In FIG. 11, a further embodiment of communications system 210 is shown. In this embodiment, housing 240 is provided with six recesses 241 in which communication units 20 and sensor units 30 can be received. In this case, the housing is provided with one communication unit 20 and five sensor units 30. Housing 240 is provided with connector mechanisms 215, in this case with two connector mechanisms provided along each side of the housing 240. As is seen in FIG. 12, multiple communications systems 210 can be secured together by connecting mechanisms 215 to form a communication system array 290. Connector mechanisms may be any suitable securing mechanism including, but not limited to, mechanical clips, magnetic connectors, projections and corresponding recesses and the like.

Arrangement of the units 20, 30, 120, 130 in a cluster formation 11, 111, 211 whether secured by strapping (not shown), a container 240 or retained in a frame 40, 140 enables new sensor communication units 20, 120 and sensor units 30, 130 to be swapped in and out of the cluster 11, 111, 211 with ease. Such ease of swapping in and out units provides the communication system 10, 110, 210 with a futureproof architecture allowing it to be customized or developed for particular environments or functions as the need arises without the requirement of creating a complete new system. Such functionality can extend the lifespan and operating functions of the system 10, 110, 210.

With reference to FIGS. 13 to 15, there is shown another embodiment of the present invention, with like components given equivalent reference numbers prefixed by 300. In FIG. 13, a handle mechanism 362 co-operates with cap 331, in this embodiment via connector 325. The handle 331 being affixed to the cap 331 of communication units 320 help manoeuvre the units 320 into position in recesses 341 of the unit body 310. In FIGS. 14 and 15 the arrangement 301 is shown provided with resilient horseshoe clips 370A, 370B which can be used to retain the unit 310 to a pipe. The horseshoe clips 370A, 370B are of particular use when a pipe has been provided with insulation which is too thick to enable magnets to provide secure attachment, or when a pipe is formed of a material which magnets will not secure to.

It will be appreciated by those skilled in the art that various modifications may be made to the invention as described herein without departing from the scope thereof. For example, local communication mechanisms have been detailed as using high frequency electromagnetic transmission however it will be appreciated that other electromagnetic signal transmission frequency may be used, or optical or acoustic transmission techniques may also be suitable for local communication within the system 10, 110. Furthermore, whilst a sealed battery unit 28 may be provided in any unit 20, 30, each unit may include a power transfer system to allow for wireless power to be transferred inductively between units and alternatively the power supply may be a renewable power generator. Clips 123, 133 have been described as protrusions, but any releasable securing mechanism could be used to removably secure the units to one another. Whilst the frames and system arrangement detailed herewithin have a linear or block structure, it will be appreciated that the system may be formed in any suitable shape. For example, the system 10 may be formed having 360 degree architecture such that it can be mounted around a pipe. This would enable multiple temperature sensors, or sensors using, for example, but not limited to, nucleonic techniques, to be deployed in positions around the pipe within a single system 10 thus providing multi-phase data which could provide information of gas/fluid interface levels, hydrate build up or corrosion.

1. A communication system comprising a communication unit having a local wireless communication mechanism, a remote wireless communication mechanism, a processor, and a power supply; and, at least one of a sensor unit having a sensor mechanism, a local wireless communication mechanism and a power supply, wherein each of the communication unit and at least one sensor unit is provided in a discreet housing and is arranged proximal to each other unit to form a cluster such that each local wireless communication mechanism can communicate data to each other local wireless communication mechanism within the cluster and the communication unit remote wireless communication mechanism is operable to communicate outwith the cluster.

2. A communication system s claimed in claim 1 wherein each discreet housing is a waterproof housing.

3. A communication system as claimed in claim 1 wherein the communication system is an underwater communication system.

4. A communication system as claimed in claim 1 further comprising at least two sensor units.

5. A communication system as claimed in claim 1 wherein each sensor unit includes functionality of at least one of a temperature sensor, accelerometer, pressure sensor, flow meter, vibration monitor, acoustic sensor, optical sensor, corrosion monitoring sensor, strain sensor, integrity sensors, oxygen level sensor.

6. A communication system as claimed in claim 1 wherein the communication system includes more than one sensor unit having a given type of functionality.

7. A communication system as claimed in claim 1 wherein the communication system comprises more than one communication unit.

8. A communication system as claimed in claim 1 wherein each communication unit and/or each sensor unit includes a power transfer system to transfer power inductively between units.

9. A communication system as claim in claim 1 wherein each sensor unit comprises a local processor mechanism.

10. A communication system as claimed in claim 1 further comprising a frame operable to receive each of the communication units and sensor units.

11. A communication system as claimed in claim 10 wherein the frame comprises a material operable to allow electromagnetic data carrying signals to propagate between local communication mechanisms.

12. A communication system as claimed claim 1 wherein each communication unit and sensor unit housing may be provided with a plurality of securing mechanisms with each securing mechanism operable to co-operate with a securing mechanism on another unit such that the units can be secured together to form a cluster.

13. A frame for a communication system, the frame comprising a plurality of recesses, each recess operable to receive one of a communication unit or a sensor unit, wherein the plurality of recesses are arranged to hold a plurality of units proximal to one another.

14. A frame as claimed in claim 13 comprising a material operable to allow electromagnetic data carrying signals to propagate wirelessly between units.

15. A communication network comprising a communication system of claim 1 and a mobile communication unit, the mobile communication unit operable to communicate with the communication system and identify the status of each communication unit and sensor unit within the communication system.

16. A communication network as claimed in claim 15 wherein the mobile communication unit is provided with at least one sensor unit wherein the mobile communication unit is operable to remove a sensor unit from the communication system and replace it with the at least one sensor unit with which the mobile communication unit is provided.

17. A communication network as claimed in claim 15 wherein the mobile communication unit is provided with at least one communication unit and is operable to remove a communication unit from the communication system and replace it with the at least one communication unit with which the mobile communication unit is provided.

18. A communication network as claimed in of claim 15 wherein the communication network further comprises a command and control centre.

19. A communication network as claimed in claim 15 wherein the communication network further comprises a user interface which enables a user to review communication system status and input control data in response to specific status outputs.
